(19) United States
(12) Patent Application Publication
(10) Pub. No.: US 2004/0121648 A1
(43) Pub. Date: Jun. 24, 2004

(54) Network device for communicating information

(75) Inventor: John von Voros, Austin, TX (US)

Correspondence Address: HAYNES AND BOONE, LLP, 901 MAIN STREET, SUITE 3100, DALLAS, TX, 75202, US

(73) Assignee: V-Squared Networks, Austin, TX

(21) Appl. No.: 10/625,402

(22) Filed: Jul. 23, 2003

Related U.S. Application Data
(60) Provisional application No. 60/398,879, filed on Jul. 26, 2002.

(51) Int. Cl. H01R 13/60

(52) U.S. Cl. 439/535

(57) ABSTRACT

A network device includes a housing. Circuitry within the housing is for communicating information between first and second communication devices. The circuitry includes a first connection for connecting to the first communication device, a second connection for connecting to the second communication device, and a power connection for connecting the circuitry to an alternating current power source. A group of electrical prongs, mounted to the housing, is for insertion into at least one receptacle of the alternating current power source, and for mechanically supporting at least a portion of the housing's weight when the group of electrical prongs is so inserted. At least a portion of the group of electrical prongs is connected to the power connection for connecting the circuitry to the alternating current power source via the power connection and the group of electrical prongs when the group of electrical prongs is so inserted.

### CLAIM TO EARLIER APPLICATION

This application claims priority to coassigned U.S. Provisional Patent Application No. 60/398,879, filed Jul. 26, 2002, entitled ELECTRICAL SOCKET NETWORK DEVICE, naming John von Voros as inventor, which is incorporated herein by reference in its entirety.

### BACKGROUND

This description relates in general to information processing systems, and in particular to a network device for communicating information.

FIGS. 1A and 1B are perspective views of a conventional network device, indicated generally at 10. The network device 10 includes a housing 12 and a separate “wall-pack” power supply 14. U.S. Pat. No. 3,880,491 to Ferro et al. describes a conventional implementation of a wall-pack power supply. Within the housing 12, the network device 10 includes circuitry for communicating information between multiple communication devices (not shown in FIGS. 1A and 1B), which are external to the housing 12.

The power supply 14 has a group of electrical prongs 16 for insertion into a conventional receptacle 18 of an alternating current (“AC”) power source. When the group of electrical prongs 16 is so inserted, the power supply 14 converts power from the AC power source (e.g., single phase, 60 Hertz at 120 volts AC) into a different type of power. Through an electrical cord 20, the power supply 14 is connected to the circuitry within the housing 12. Accordingly, the circuitry within the housing 12 is connected to the AC power source via the electrical cord 20 and the power supply 14 (including via the group of electrical prongs 16) when the group of electrical prongs 16 is so inserted, so that the electrical cord 20 transmits the converted power to the circuitry within the housing 12.

In the example of FIGS. 1A and 1B, the network device 10 is a wireless access point (“WAP”) for standard wireless computer networks, including:

(a) diagnostic light emitting diodes (“LEDs”) 22 for visually indicating status;

(b) antennae 24 for connecting the network device 10 to external communication devices via a wireless medium (e.g., air or space);

(c) a serial port 26 for connecting the network device 10 to an external communication device via a serial interface cable;

(d) a parallel port 28 for connecting the network device 10 to an external communication device via a parallel interface cable;

(e) a Universal Serial Bus (“USB”) port 30 for connecting the network device 10 to an external communication device via a USB interface cable;

(f) a wide area network (“WAN”) port 32 for connecting the network device 10 via an Ethernet cable and an external communication device (e.g., a router) to a wide area network;

(g) Ethernet switch ports 34 for connecting the network device 10 to external communication devices (e.g., computer systems) via respective Ethernet cables; and

(h) a reset switch 36 for selectively resetting the network device 10.

Accordingly, the antennae 24, serial port 26, parallel port 28, USB port 30, WAN port 32, and Ethernet switch ports 34 are connections for connecting the circuitry (within the housing 12) to various external communication devices.

With the network device 10, a potential shortcoming is that a human might trip over the cord 20, which may damage or inadvertently reset the network device 10. Another potential shortcoming is that the network device 10 is (a) placed on a horizontal surface (e.g., table) and/or (b) mounted to a surface (e.g., wall or ceiling) with special attachment hardware or an adhesive substance (e.g., glue). For example, it may be difficult to readily identify a proper surface.

Also, (a) the surface may be occupied in an inefficient manner, (b) extra cabling (e.g., a power extension cord) may result from placement or mounting of the network device 10, (c) theft or vandalism may be possible in public or corporate areas, (d) the placement or mounting may be perceived as aesthetically unattractive, (e) mounting may present a mechanical challenge, (f) unauthorized disablement may be possible, such as by unplugging the power supply 14 from the receptacle 18, and (g) another device may not be connected to the AC power source via the receptacle 18 when the group of electrical prongs 16 is so inserted.

Accordingly, a need has arisen for a network device for communicating information, in which various shortcomings of previous techniques are overcome.

### SUMMARY

A network device includes a housing. Circuitry within the housing is for communicating information between first and second communication devices. The circuitry includes a first connection for connecting to the first communication device, a second connection for connecting to the second communication device, and a power connection for connecting the circuitry to an alternating current power source. A group of electrical prongs, mounted to the housing, is for insertion into at least one receptacle of the alternating current power source, and for mechanically supporting at least a portion of the housing's weight when the group of electrical prongs is so inserted. At least a portion of the group of electrical prongs is connected to the power connection for connecting the circuitry to the alternating current power source via the power connection and the group of electrical prongs when the group of electrical prongs is so inserted.

A principal advantage of one or more of the illustrative embodiments is that various shortcomings of previous techniques are overcome. For example, a proper surface may be more readily identified for locating the network device. Also, in one or more of the illustrative embodiments, (a) the surface may be more readily occupied in an efficient manner, (b) extra cabling (e.g., a power extension cord) does not result from placement or mounting of the network device, (c) theft or vandalism is more readily avoidable in public or corporate areas, (d) the placement or mounting may be perceived as more aesthetically attractive, (e) mounting is more readily achievable without presenting a mechanical challenge, (f) unauthorized disablement is more readily avoidable, and (g) another device may be connected to the alternating current power source via the receptacle when the group of electrical prongs is so inserted.

### BRIEF DESCRIPTION OF THE DRAWING

FIGS. 1A and 1B are perspective views of a conventional network device.

FIGS. 2A, 2B and 2C are perspective views of a network device, according to a first illustrative embodiment.

FIG. 3 is an exploded perspective view of a network device, according to a second illustrative embodiment.

FIG. 4 is a block diagram of a network device, according to the illustrative embodiments of FIGS. 2A-C and 3.

FIG. 5 is a view of a first screen displayed by a display device of a computer system that is connected via a network to the network device, according to the illustrative embodiments.

FIG. 6 is a diagram of a first network, according to the illustrative embodiments.

FIG. 7 is a diagram of a second network, according to the prior art.

FIG. 8 is a diagram of a third network, according to the illustrative embodiments.

FIG. 9 is a flowchart of an installation and configuration operation, according to the illustrative embodiments.

FIG. 10 is a view of a second screen displayed by a display device of a computer system, according to the illustrative embodiments.

FIG. 11 is a block diagram of a representative computer system, according to the illustrative embodiments.

### DETAILED DESCRIPTION

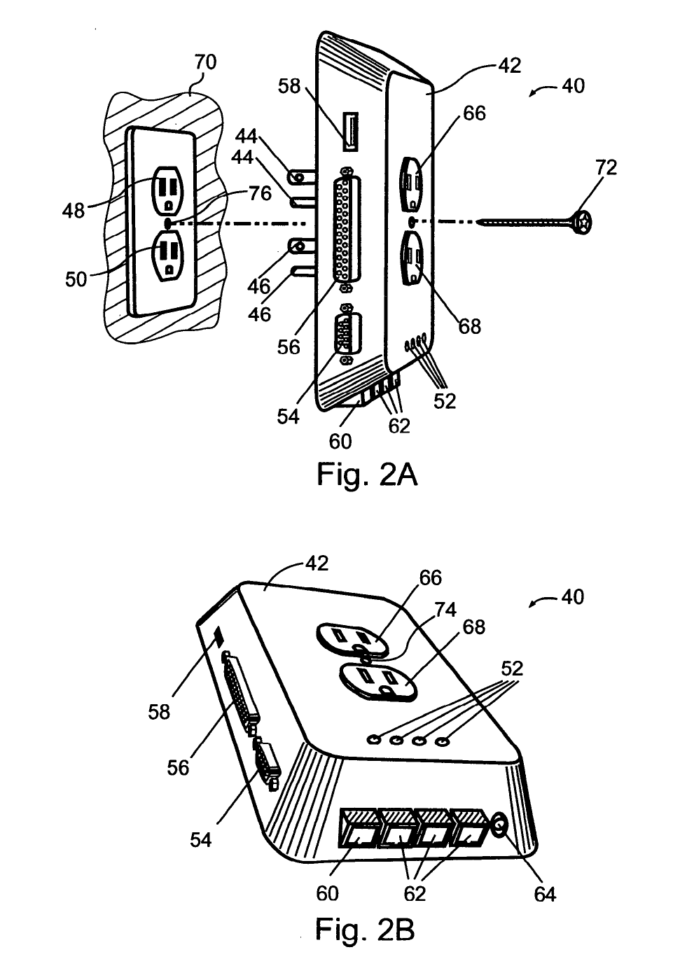

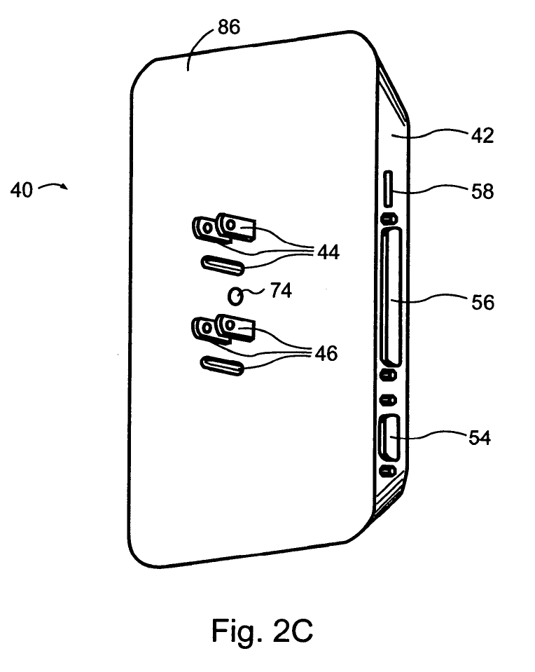

FIGS. 2A, 2B and 2C are perspective views of a network device, indicated generally at 40, according to a first illustrative embodiment. The network device 40 includes a housing 42. Within the housing 42, the network device 40 includes electronic circuitry for communicating information between multiple communication devices (not shown in FIGS. 2A-C), which are external to the housing 42, including circuitry for multiplexing a communication of a first communication device between second and third communication devices. For example, such communication device may be a device that is substantially identical to the network device 40.

The network device 40 includes a conventional group of electrical prongs, including a first group of electrical prongs 44 and an optional second group of electrical prongs 46. The first and second groups of electrical prongs 44 and 46 are mounted to the housing 42. The first group of electrical prongs 44 is for insertion into a first primary receptacle 48 of a conventional AC power source. The second group of electrical prongs 46 is for insertion into a second primary receptacle 50 of the AC power source. When the first and second groups of electrical prongs 44 and 46 are so inserted, they mechanically support at least a portion of a weight of the housing 42.

In the example of FIGS. 2A-C, the network device 40 is a wireless access point (“WAP”), including:

(a) diagnostic LEDs 52 for visually indicating status;

(b) a serial port 54 for connecting the network device 40 to an external communication device via a serial interface cable;

(c) a parallel port 56 for connecting the network device 40 to an external communication device via a parallel interface cable;

(d) a USB port 58 for connecting the network device 40 to an external communication device via a USB interface cable;

(e) a WAN port 60 for connecting the network device 40 via an Ethernet cable and an external communication device (e.g., a router) to a wide area network;

(f) Ethernet switch ports 62 for connecting the network device 40 to external communication devices (e.g., computer systems) via respective Ethernet cables; and

(g) a reset switch 64 for selectively resetting the network device 40.

Accordingly, the serial port 54, parallel port 56, USB port 58, WAN port 60, and Ethernet switch ports 62 are connections for connecting the circuitry (within the housing 42) to various external communication devices.

Also, the network device 40 includes a first extension receptacle 66 and a second extension receptacle 68. The first and second extension receptacles 66 and 68 are mounted to the housing 42. As shown in FIG. 2A, the primary receptacles 48 and 50 are mounted within a wall 70 and are exposed to an outer surface of the wall 70.

The network device 40 includes a structure for securing the housing 42 to the wall 70 when the groups of electrical prongs 44 and 46 are inserted in primary receptacles 48 and 50, respectively. Such structure includes a threaded screw 72 and a hole 74 for securing the housing 42 to the wall 70. The screw 72 is inserted through the hole 74 of the housing 42 and is screwed through a threaded hole 76 of the wall 70, in order to secure the housing 42 to the primary receptacles 48 and 50, which likewise secures the housing 42 to the wall 70. In the illustrative embodiments, the screw 72 is a standard commodity screw. In an alternative embodiment, the screw 72 has a customized head that requires a customized screwdriver, which enhances anti-theft/anti-vandalism properties.

When the first group of electrical prongs 44 is inserted into the first primary receptacle 48, the first extension receptacle 66 is connected to the AC power source via the first group of electrical prongs 44 and the first primary receptacle 48. Likewise, when the second group of electrical prongs 46 is inserted into the second primary receptacle 50, the second extension receptacle 68 is connected to the AC power source via the second group of electrical prongs 46 and the second primary receptacle 50.

A first plug of a first extension device (not shown in FIGS. 2A-C) is insertable into the first extension receptacle 66. Accordingly, the first extension receptacle 66 connects the first extension device to the AC power source via the first plug and the first group of electrical prongs 44 when the first plug and the first group of electrical prongs 44 are so inserted.

Likewise, a second plug of a second extension device (not shown in FIGS. 2A-C) is insertable into the second extension receptacle 68. Accordingly, the second extension receptacle 68 connects the second extension device to the AC power source via the second plug and the second group of electrical prongs 46 when the second plug and the second group of electrical prongs 46 are so inserted.

In the illustrative embodiment, the extension receptacles 66 and 68 have the same conventional connector type as the primary receptacles 48 and 50. In an alternative embodiment, the extension receptacles 66 and 68 have a first connector type, and the primary receptacles 48 and 50 have a second connector type. In various alternative embodiments, the extension receptacles 66 and 68 have a connector type that is adapted to specific countries or regions of the world. In some alternative embodiments, the network device 40 includes circuitry for converting power in accordance with requirements of specific countries or regions of the world. In other alternative embodiments, the network device 40 has additional extension receptacles.

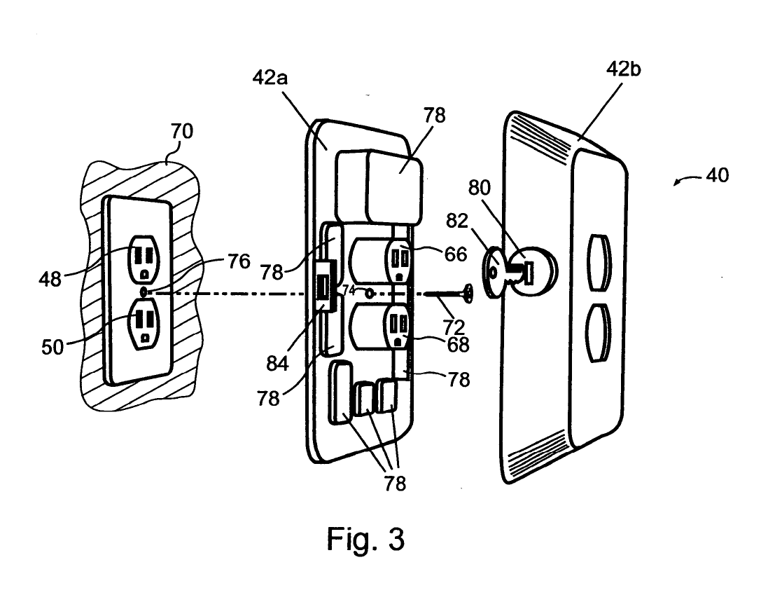

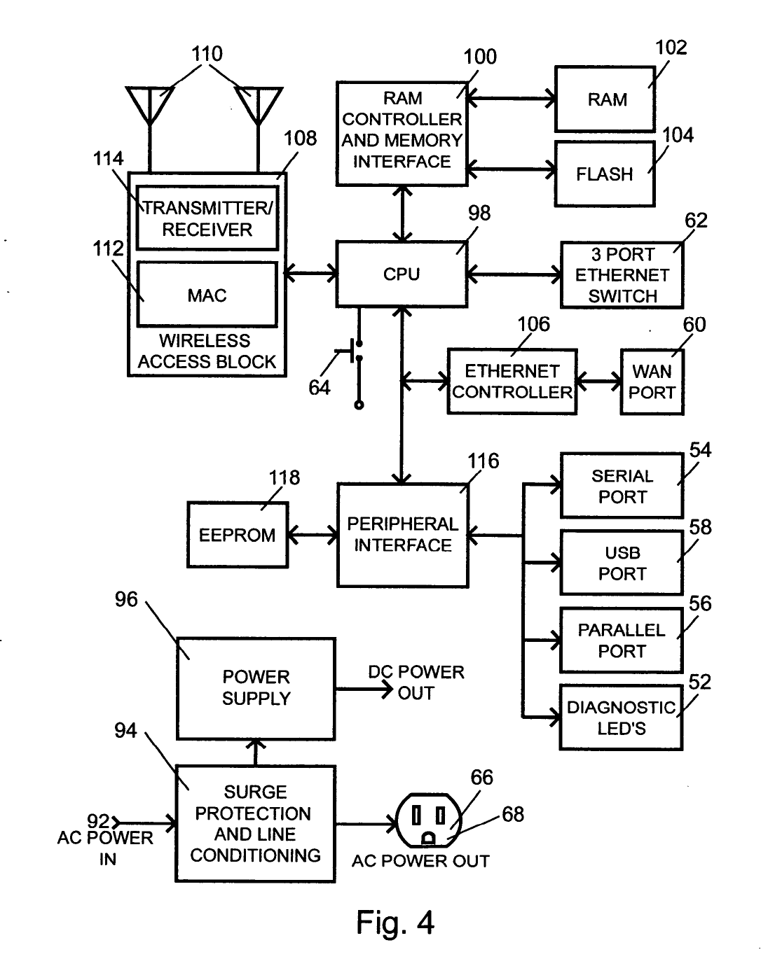

FIG. 3 is an exploded perspective view of the network device 40, according to a second illustrative embodiment. In the second illustrative embodiment, the housing 42 has two primary components 42a and 42b, as shown in FIG. 3. The groups of electrical prongs 44 and 46, together with the extension receptacles 66 and 68, are mounted to the housing 42a. Also, various electronic circuitry 78 is mounted to the housing 42a. In an illustrative embodiment, the electronic circuitry 78 is mounted to the housing 42a, and the groups of electrical prongs 44 and 46 (and the extension receptacles 66 and 68) are mounted to the housing 42a by mounting to the circuitry 78. The circuitry 78 is discussed further hereinbelow in connection with FIG. 4.

The primary difference between the network device 40 of FIG. 3 (according to the second illustrative embodiment) and the network device 40 of FIGS. 2A-C (according to the first illustrative embodiment) is the structure for securing the housing 42 to the wall 70 when the groups of electrical prongs 44 and 46 are inserted in primary receptacles 48 and 50, respectively. In the second illustrative embodiment, as shown in FIG. 3, the screw 72 is inserted through the hole 74 of the housing 42a and is screwed through the hole 76 of the wall 70, in order to secure the housing 42a to the primary receptacles 48 and 50, which likewise secures the housing 42a to the wall 70.

The housing 42b is a cover for selectively preventing access to the screw 72. By selectively preventing access to the screw 72, the housing 42b selectively prevents detachment of the housing 42a from the wall 70. Such access to the screw 72 is selectively prevented by a locking device 80, into which a key 82 is insertable.

Accordingly, after the housing 42b is positioned to cover the housing 42a, if the inserted key 82 is clockwise rotated to cause a locked engagement between the locking device 80 of the housing 42b and a slot 84 of the housing 42a, then the housing 42b is secured and locked to the housing 42a and selectively prevents access to the screw 72. After such engagement, the key 82 is removable from the locking device 80 to prevent unlocking. Conversely, if the inserted key 82 is counterclockwise rotated to undo the locked engagement between the locking device 80 and the slot 84, then the housing 42b is unlocked and removable from the housing 42a, and the screw 72 is accessible.

For clarity, the groups of electrical prongs 44 and 46, diagnostic LEDs 52, serial port 54, parallel port 56, USB port 58, WAN port 60, and Ethernet switch ports 62 are not shown in FIG. 3. Nevertheless, the network device 40 of the second illustrative embodiment includes such components, which are mounted to the housing 42a and accessible through suitable corresponding openings in the housing 42b. In an alternative embodiment, the housing 42b does not have one or more of such openings, but such components (for which such openings are absent) are connected to other devices via cabling that is routed through a back of the network device 42 (e.g., a back 86 of FIG. 2C) and behind the wall 70, which enhances anti-theft/anti-vandalism properties.

FIG. 4 is a block diagram of the network device 40, according to the first and second illustrative embodiments. The network device 40 includes electronic circuitry, indicated generally at 90, for communicating information between multiple communication devices (not shown in FIG. 4), which are external to the network device 40, including circuitry for multiplexing a communication of a first communication device between second and third communication devices. The first group of electrical prongs 44 (FIGS. 2A and 2C) is connected to a power connection 92 for connecting the circuitry 90 to the AC power source via the power connection 92 and the first group of electrical prongs 44 when the first group of electrical prongs 44 is inserted into the first primary receptacle 48 (FIG. 2A and FIG. 3).

The circuitry 90 includes a surge protection & line conditioning module 94 for protecting the circuitry 90 against a surge in power from the AC power source and for conditioning power from the AC power source. Also, the circuitry 90 includes a power supply 96, which converts the conditioned power output from the surge protection & line conditioning module 94 (e.g., single phase, 60 Hertz at 120 volts AC) into direct current (“DC”) power. For clarity, the connection between the DC power output (from the power supply 96) and various other elements of circuitry 90 is not shown in FIG. 4. Nevertheless, the power supply 96 is connected to such elements of circuitry 90, so that the power supply 96 transmits the DC power to such elements. Accordingly, when the first group of electrical prongs 44 is inserted into the first primary receptacle 48, the circuitry 90 is connected to the AC power source via the power supply 96, the surge protection & line conditioning module 94, the power connection 92, the first group of electrical prongs 44 and the first primary receptacle 48.

Also, when the first group of electrical prongs 44 is inserted into the first primary receptacle 48, the first extension receptacle 66 is connected to the AC power source via the surge protection & line conditioning module 94, the power connection 92, the first group of electrical prongs 44 and the first primary receptacle 48. Likewise, when the second group of electrical prongs 46 is inserted into the second primary receptacle 50, the second extension receptacle 68 is connected to the AC power source via the surge protection & line conditioning module 94, the power connection 92, the second group of electrical prongs 46 and the second primary receptacle 50. Accordingly, the extension receptacles 66 and 68 receive conditioned power output from the surge protection & line conditioning module 94.

In various alternative embodiments, the surge protection & line conditioning module 94 and the power supply 96 are suitable for conditioning and converting power in accordance with requirements of specific countries or regions of the world.

The circuitry 90 includes a central processing unit (“CPU”) 98, which controls various operations of the network device 90, manages higher level network protocols, and manages interfaces to the external communication devices. For example, the CPU 98 is suitable for executing software to implement Simple Network Management Protocol (“SNMP”) and other management protocols. The CPU 98 is connected to the Ethernet switch ports 62.

Also, the circuitry 90 includes a RAM controller & memory interface 100, which is connected to the CPU 98, a random access memory (“RAM”) 102, and a non-volatile flash memory 104. In coordination with the CPU 98, the RAM controller & memory interface 100 manages a transfer of information between the CPU 98, the RAM 102 and flash memory 104. The RAM 102 and flash memory 104 store such information, including software instructions for execution by the CPU 98 and associated data.

Moreover, the circuitry 90 includes a conventional Ethernet controller 106, which is connected to the CPU 98 and the WAN port 60. In coordination with the CPU 98, the Ethernet controller 106 manages a communication of information between the CPU 98 and the WAN port 60. For example, the WAN port 60 is suitable for connection to an external cable modem or digital subscriber line (“DSL”) modem to provide global computer network (e.g., Internet) access for homes and small businesses.

In an alternative embodiment, such modems are integrated within the network device 40 to provide a more compact solution, thereby reducing a number of external power supplies and cables, so that support costs would be reduced for Internet service providers (“ISPs”) that supply networking equipment with their services. In larger networks, Internet access would be provided via a router connected to higher speed telecommunication circuits. Accordingly, via the WAN port 60, the network device 40 is operable to communicate information between a first external communication device (e.g., connected to one of the Ethernet switch ports 62) and any other external communication device that is connected to the Internet (e.g., web site servers).

The circuitry 90 includes one or more conventional wireless access blocks 108, which are connected to the CPU 98. The wireless access blocks 108 include antennae 110, for connecting to external communication devices via a wireless medium (e.g., air or space). For example, each wireless access block 108 includes a respective media access control (“MAC”) processor 112 and a radio frequency (“RF”) transmitter/receiver 114. The network device 40 includes a suitable number of wireless access blocks 108 to accommodate a sufficient range of communications frequencies and techniques.

The antennae 110 are suitable to accommodate a sufficient range of applications and environments. According to such applications and environments, the antennae 110 are either internal or external to the housing 42 (FIGS. 2A-C and 3). In coordination with the CPU 98, the MAC processor 112 manages radio operations and other standard communication protocol operations and error checking. The RF transmitter/receiver 114 manages a wireless communication of information between the network device 40 and external communication devices, according to a standard communication protocol. In the illustrative embodiments, each wireless access block 108 is located on a separate circuit board (e.g., a Personal Computer Memory Card International Association (“PCMCIA”) card) within the housing 42, so that the wireless access block 108 is readily replaceable to adjust for changes in standard communication protocols and emerging new technologies.

The circuitry 90 includes a peripheral interface circuit 116, which is connected to the CPU 98, the diagnostic LEDs 52, the serial port 54, the parallel port 56, and the USB port 58. In coordination with the CPU 98, the peripheral interface circuit 116 manages a communication of information between the CPU 98 and various external communication devices that are connected to the serial port 54, the parallel port 56, or the USB port 58. Also, in coordination with the CPU 98, the peripheral interface circuit 116 manages a selective illumination of the diagnostic LEDs 52 for visually indicating status of such communication (e.g., connectivity, availability, and operability of an external communication device).

Moreover, the circuitry 90 includes an electrically erasable programmable read-only memory (“EEPROM”) 118, which is connected to the peripheral interface 116. The EEPROM 118 is a non-volatile memory for storing configuration and network address information. In response to such configuration information, the peripheral interface 116 performs its various operations.

In an example operation, the serial port 54 is connected to a computer system (not shown in FIG. 4) for diagnostic and management purposes. In another example operation, the parallel port 56 or USB port 58 is connected to an external print device (not shown in FIG. 4), so that the network device 40 operates as a print server. Also, the CPU 98 is connected to the manually operated reset switch 64 for selectively resetting the network device 40, as for example in the event of failure or initialization of the network device 40.

The network device 40 is operable to serve as a wireless access point, an Ethernet switch, a wireless-to-wired network bridge, a print server, and/or a firewall for network security. It supports demilitarized zone (“DMZ”) hosting, dynamic host configuration protocol (“DHCP”) for assigning Internet protocol (“IP”) addresses, Point-to-Point Tunneling Protocol (“PPTP”), point-to-point protocol over Ethernet (“PPPoE”), and IP security (“IPSec”) Pass through, filtering, forwarding, mapping, logging, and remote administration.

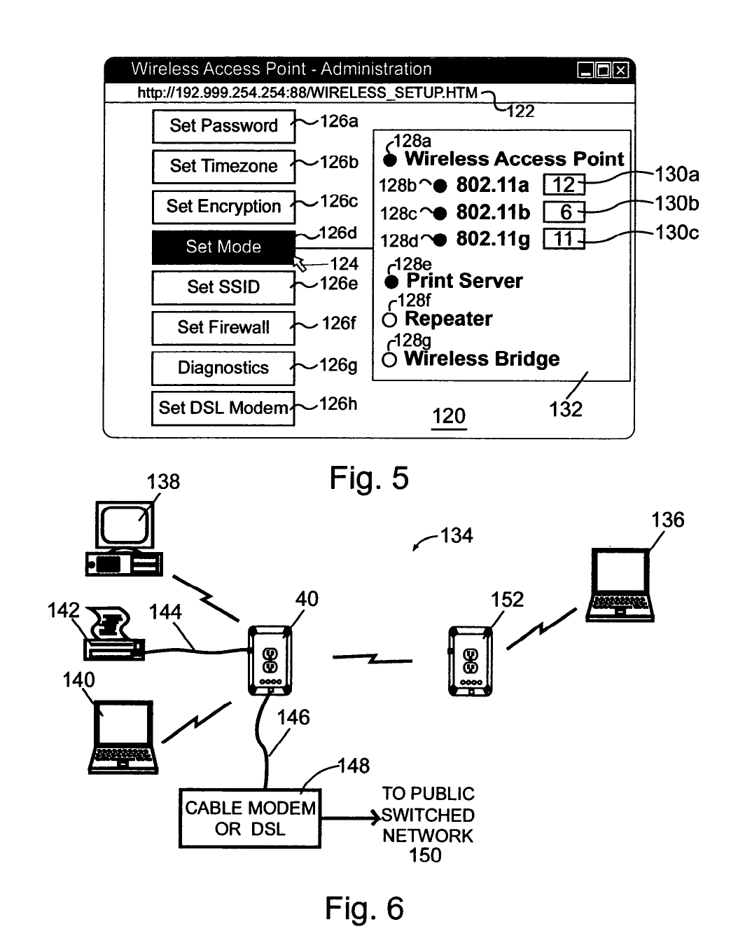

FIG. 5 is a view of a screen 120 displayed by a display device of a human administrator's computer system that is connected via a network to the network device 40, according to the illustrative embodiments. The computer system executes browser software, such as Microsoft Internet Explorer software. The network device 40 has an assigned IP address and is configured via the network and the computer system's browser software.

The screen 120 is a graphical user interface management console screen, which is displayed by the display device in response to (a) the computer system's execution of the browser software and (b) signals from the network device 40. The network device 40 outputs those signals via the network to the computer system for causing the display device to display various elements of the screen 120.

For security purposes, in the illustrative embodiments (e.g., if the network device 40 operates as a wireless access point), the network device 40 outputs signals via the network to the computer system for causing the display device to display a different screen before the screen 120. The different screen asks the administrator to enter a login name and password via the browser software before obtaining access to the screen 120.

The screen 120 includes a Uniform Resource Locator (“URL”) field 122, which is a region of the screen 120 in which the administrator is able to specify a URL address. In the example of FIG. 5, the administrator-specified URL address is http://192.999.254.254:88/WIRELESS_SETUP.HTM, which specifies the route via the network to the network device 40 (which is suitable for operation as a global computer network facility).

The administrator specifies the URL address by selecting the URL field 122 and specifying alphanumeric character information of the URL address for display within the URL field 122. For example, the administrator selects the URL field 122 by (a) operating the computer system's pointing device to position a cursor 124 overlapping with the URL field 122 and (b) after so positioning the cursor 124, activating a switch of the pointing device. Such selection of a region (such as the URL field 122) of the screen 120 by the administrator is hereinafter referred to as the administrator “clicking” such region.

After clicking (or “selecting”) the URL field 122, the administrator is able to specify alphanumeric character information of the URL address for display within the URL field 122. For example, the administrator specifies such information by (a) operating the computer system's electronic keyboard, so that the screen 120 displays such information within the selected field (such as the URL field 122) and (b) pressing the keyboard's “Enter” key. Such operation of the electronic keyboard by the administrator is hereinafter referred to as the administrator “typing” or “entering” such information.

After the administrator specifies the URL address, the administrator is able to cause the computer system to output (or “transmit” or “send”) the URL address to the network, as for example by pressing the keyboard's “Enter” key. In response to such transmission of the URL address, the network communicates with the network device 40. The network device 40 detects such communication and responds accordingly by outputting various signals via the network to the computer system.

Accordingly, via the network, the computer system receives such signals from the network device 40, such as HyperText Markup Language (“HTML”) commands or EXtensible Markup Language (“XML”) commands. In response thereto, the computer system outputs one or more signals to the computer system's display device, so that the display device displays the screen 120.

The screen 120 includes a first set of “buttons” 126a, 126b, 126c, 126d, 126e, 126f, 126g and 126h, which are regions of the screen 120. Also, the screen 120 includes a second set of buttons 128a, 128b, 128c, 128d, 128e, 128f and 128g, which are regions of the screen 120. Further, the screen 120 includes a set of fields 130a, 130b and 130c, which are regions of the screen 120 in which the administrator is able to specify information. The buttons 128a-g and the fields 130a-c are part of a “Set Mode” subscreen 132 of the screen 120. Each button and field of the screen 120 (e.g., each of buttons 126a-h and 128a-g, and fields 122 and 130a-c) is individually clickable by the administrator.

The button 126a is a “Set Password” button. In response to the administrator clicking the button 126a, the network device 40 outputs signals via the network to the computer system for causing the display device to display a subscreen (of screen 120) that asks the administrator to specify (e.g., by typing) a login name and password of the network device 40. After the administrator specifies the login name and password, the computer system outputs the login name and password information via the network to the network device 40. The network device 40 stores such information in the flash memory 104 (FIG. 4) and performs its subsequent operations according to such information. For example, the administrator will be asked to enter the same login name and password via the browser software before obtaining access to the screen 120, as discussed above for security purposes.

The button 126b is a “Set Timezone” button. In response to the administrator clicking the button 126b, the network device 40 outputs signals via the network to the computer system for causing the display device to display a subscreen (of screen 120) that asks the administrator to specify a time zone (e.g., U.S. Central) in which the network device 40 is located. After the administrator specifies the time zone, the computer system outputs the time zone information via the network to the network device 40. The network device 40 stores such information in the flash memory 104 (FIG. 4) and performs its subsequent operations according to such information

The button 126c is a “Set Encryption” button. In response to the administrator clicking the button 126c, the network device 40 outputs signals via the network to the computer system for causing the display device to display a subscreen (of screen 120) that asks the administrator to specify an encryption mode for communicating information via nodes of the network between the computer system and the network device 40. After the administrator specifies the encryption mode, the computer system outputs the encryption mode information via the network to the network device 40. The network device 40 stores such information in the flash memory 104 (FIG. 4) and performs its subsequent operations according to such information.

The button 126d is a “Set Mode” button. In response to the administrator clicking the button 126d, the network device 40 outputs signals via the network to the computer system for causing the display device to display the “Set Mode” subscreen 132 (of screen 120) that asks the administrator to specify a mode of operation of the network device 40. After the administrator specifies the mode of operation, the computer system outputs the operation mode information via the network to the network device 40. The network device 40 stores such information in the flash memory 104 (FIG. 4) and performs its subsequent operations according to such information.

In the example of FIG. 5, the “Set Mode” subscreen 132 includes the buttons 128a-g and the fields 130a-c. By clicking the button 128a, the administrator is able to select a “wireless access point” mode of operation of the network device 40. In such a mode, the network device 40 accordingly operates as a wireless access point.

By clicking one or more of the buttons 128b, 128c and 128d, the administrator is able to select whether the “wireless access point” mode of operation is compliant with one or more of the Institute of Electrical and Electronics Engineers (“IEEE”) communication standards 802.11a, 802.11b and 802.11g, respectively. For each of the selected standards 802.11a, 802.11b and 802.11g, the administrator is able to specify a respective channel of operation by typing the channel's number in an associated one of the fields 130a-c. Similarly, by clicking one or more of the buttons 128e, 128f and 128g, the administrator is able to select whether the network device 40 operates as a print server, a repeater, or a wireless bridge, respectively.

The button 126e is a “Set SSID” button. In response to the administrator clicking the button 126e, the network device 40 outputs signals via the network to the computer system for causing the display device to display a subscreen (of screen 120) that asks the administrator to specify a service set identifier (“SSID”) of the network device 40. After the administrator specifies the SSID, the computer system outputs the SSID information via the network to the network device 40. The network device 40 stores such information in the flash memory 104 (FIG. 4) and performs its subsequent operations according to such information.

The button 126f is a “Set Firewall” button. In response to the administrator clicking the button 126f, the network device 40 outputs signals via the network to the computer system for causing the display device to display a subscreen (of screen 120) that asks the administrator to specify a network security firewall configuration of the network device 40. After the administrator specifies the firewall configuration, the computer system outputs the firewall configuration information via the network to the network device 40. The network device 40 stores such information in the flash memory 104 (FIG. 4) and performs its subsequent operations according to such information.

The button 126g is a “Diagnostics” button. In response to the administrator clicking the button 126g, the network device 40 outputs signals via the network to the computer system for causing the display device to display a subscreen (of screen 120) that asks the administrator to specify a diagnostic process of the network device 40. After the administrator specifies the diagnostic process, the computer system outputs the diagnostic process information via the network to the network device 40. The network device 40 stores such information in the flash memory 104 (FIG. 4) and performs its subsequent operations according to such information.

The button 126h is a “Set DSL Modem” button. In response to the administrator clicking the button 126h, the network device 40 outputs signals via the network to the computer system for causing the display device to display a subscreen (of screen 120) that asks the administrator to specify a DSL modem configuration of the network device 40. After the administrator specifies the DSL modem configuration, the computer system outputs the DSL modem configuration information via the network to the network device 40. The network device 40 stores such information in the flash memory 104 (FIG. 4) and performs its subsequent operations according to such information.

Accordingly, after obtaining access to the screen 120, the administrator remotely configures (or sets or initializes) the network device 40 to perform various operations, so that the network device 40 is remotely controllable by the administrator's computer system. In the example of FIG. 5, the administrator has configured the network device 40 to operate as a wireless access point, compliant with IEEE communication standards 802.11a, 802.11b and 802.1 μg, and as a print server.

In alternative embodiments, the administrator is able to configure the network device 40 using Telnet for text-based configuration via the network, or by attaching the network device 40 directly to the computer system via the USB, serial, parallel, or Ethernet ports of the network device 40. The network device 40 is useful in one or more operational modes simultaneously (i.e., wireless access point, repeater, and bridge). Accordingly, a system may include various wireless devices that are substantially identical to the network device 40.

FIG. 6 is a diagram of a network, indicated generally at 134, according to the illustrative embodiments. The network 134 is suitable for installation and operation in homes and small offices. The network 134 includes computer systems 136, 138 and 140. As shown in FIG. 6, computer systems 136 and 140 are laptop computers, and computer system 138 is a desktop computer.

Also, the network 134 includes a print device 142. The print device 142 is connected via a cable 144 (e.g., either a parallel cable or USB cable) to the network device 40, which is remotely configurable by the administrator to operate as a print server for the print device 142. In such a configuration, the network device 40 executes embedded firmware or software that is stored in the flash memory 104 (FIG. 4). Although FIG. 6 shows the network device 40 connected via the cable 144 to the print device 142, the network device 40 is likewise equipped to operate as a print server for the print device 142 via a wireless connection.

In the example of FIG. 6, the network device 40 is remotely configurable by the administrator to operate as a wireless access point for the computer systems 138 and 140 (and for other suitably equipped computer systems that are located within a wireless communication range of the network device 40). As shown in FIG. 6, the network device 40 is connected via a cable 146 (and via either a cable modem or DSL network connection 148) to a public switched network 150, so that the computer systems 138 and 140 communicate with the public switched network 150 via the network device 40 (if the computer systems 138 and 140 are within a wireless communication range of the network device 40). For example, the public switched network 150 may be the Internet. Accordingly, the network device 40 is suitable for operation as an Internet gateway, a DHCP server, a firewall, and a print server.

The network 134 also includes a network device 152, which is substantially identical to the network device 40. Accordingly, like the network device 40, the network device 152 is suitable for deployment as a wireless repeater. In the example of FIG. 6, the network device 152 is remotely configurable by the administrator to operate as a wireless repeater between the network device 40 and the computer system 136. The network device 152 operates as such a repeater if it is within a wireless communication range of the network device 40 and the computer system 136, so that the computer system 136 communicates with the public switched network 150 via the network devices 40 and 152. Likewise, the network device 152 operates as such a repeater between the network device 40 and other suitably equipped computer systems that are located within a wireless communication range of the network device 152 (so long as the network device 152 is within a wireless communication range of the network device 40).

In that manner, the network device 40 operates as a master wireless access point for the network 134. In the example of FIG. 6, the network devices 40 and 152 are compliant with the same IEEE wireless communication standard and operate with only a small degradation of performance in comparison to a fully wired alternative. In an alternative embodiment, the network devices 40 and 152 are compliant with multiple wireless communication standards. Referring also to FIGS. 2A-C and 3, a plug of the computer system 138 (or 140) or the print device 142 is insertable into either of the extension receptacles 66 or 68 for connection to (and receipt of power from) the AC power source via such plug, such extension receptacle, and such extension receptacle's connected group of electrical prongs (i.e., either the group of electrical prongs 44 or 46).

FIG. 7 is a diagram of a network, indicated generally at 154, according to the prior art. The network 154 is suitable for installation and operation in large buildings. The network 154 includes computer systems 156, 158, 160, 162, 164 and 166. As shown in FIG. 7, (a) computer systems 160, 162 and 166 are laptop computers, and (b) computer systems 156, 158 and 164 are desktop computers.

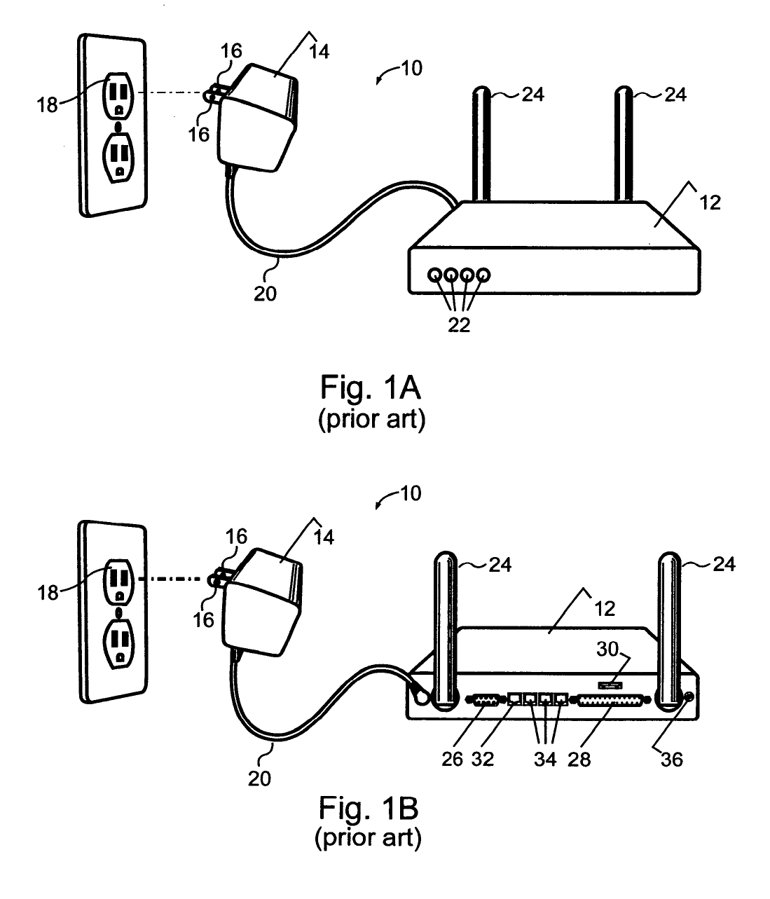

A network device 168 (e.g., similar to the network device 10 of FIGS. 1A-B) is configured to operate as a wireless access point for the computer system 156 (and for other suitably equipped computer systems that are located within a wireless communication range of the network device 168). As shown in FIG. 7, the network device 168 is connected via a cable 170 to a hub (or switch) 172. The hub 172 is connected via a cable 174 (and via either a cable modem, a DSL modem, or a router based network connection 174) to a public switched network 178, so that the computer system 156 communicates with the public switched network 178 via the network device 168 (if the computer system 156 is within a wireless communication range of the network device 168).

Also, a network device 180 (e.g., similar to the network device 10 of FIGS. 1A-B) is configured to operate as a wireless access point for the computer systems 158 and 160 (and for other suitably equipped computer systems that are located within a wireless communication range of the network device 180). As shown in FIG. 7, the network device 180 is connected via a cable 182 to the hub 172, so that the computer systems 158 and 160 communicate with the public switched network 178 via the network device 180 (if the computer systems 158 and 160 are within a wireless communication range of the network device 180).

Further, a network device 184 (e.g., similar to the network device 10 of FIGS. 1A-B) is configured to operate as a wireless access point for the computer system 162 (and for other suitably equipped computer systems that are located within a wireless communication range of the network device 184). As shown in FIG. 7, the network device 184 is connected via a cable 186 to the hub 172, so that the computer system 162 communicates with the public switched network 178 via the network device 184 (if the computer system 162 is within a wireless communication range of the network device 184).

Moreover, a network device 188 (e.g., similar to the network device 10 of FIGS. 1A-B) is configured to operate as a wireless access point for the computer systems 164 and 166 (and for other suitably equipped computer systems that are located within a wireless communication range of the network device 188). As shown in FIG. 7, the network device 188 is connected via a cable 190 to the hub 172, so that the computer systems 164 and 166 communicate with the public switched network 178 via the network device 188 (if the computer systems 164 and 166 are within a wireless communication range of the network device 188).

Each of the network devices 168, 180, 184 and 188 is connected via a respective cable to the hub 172. Accordingly, the network 154 includes a significant amount of cabling (e.g., cables 170, 182, 186 and 190) for installation in large buildings and other wide areas. For installation in some environments, such as schools, airports, buildings with asbestos, hospitals, historical buildings, and hotels, such cabling is very expensive.

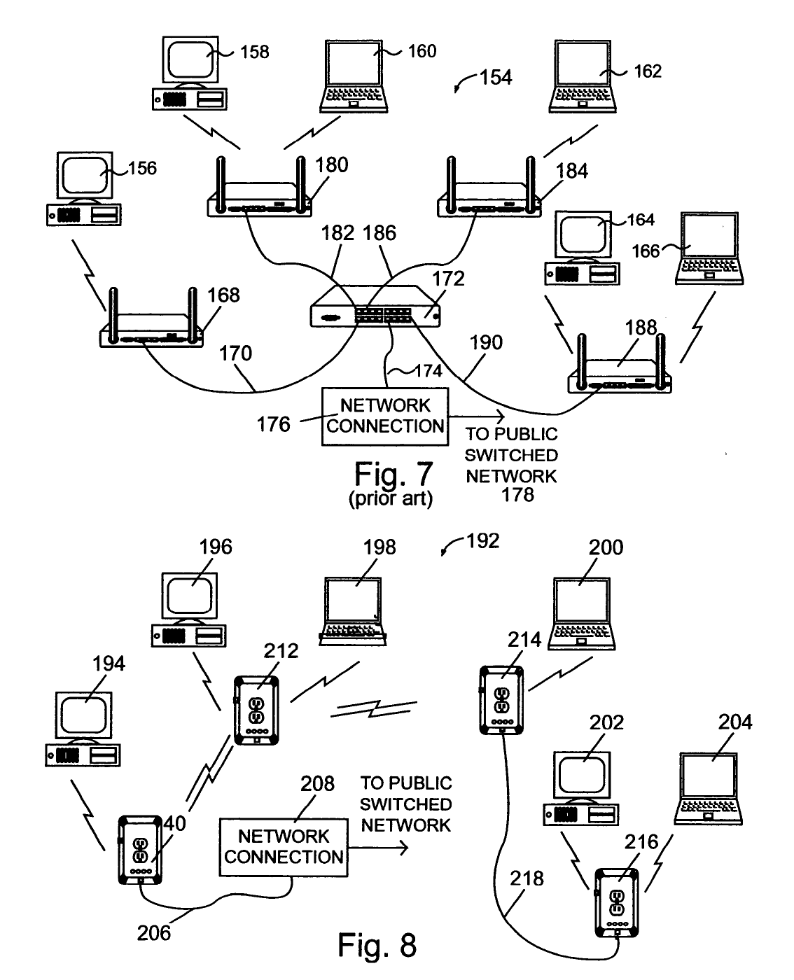

FIG. 8 is a diagram of a network, indicated generally at 192, according to the illustrative embodiments. The network 192 is suitable for installation and operation in large buildings. The network 192 includes computer systems 194, 196, 198, 200, 202 and 204. As shown in FIG. 8, (a) computer systems 198, 200 and 204 are laptop computers, and (b) computer systems 194, 196 and 202 are desktop computers.

In the example of FIG. 8, the network device 40 is remotely configurable by the administrator to operate as a wireless access point for the computer system 194 (and for other suitably equipped computer systems that are located within a wireless communication range of the network device 40). As shown in FIG. 8, the network device 40 is connected via a cable 206 (and via either a cable modem, a DSL modem, or a router based network connection 208) to a public switched network 210, so that the computer system 194 communicates with the public switched network 210 via the network device 40 (if the computer system 194 is within a wireless communication range of the network device 40).

The network 192 also includes network devices 212 and 214, which are substantially identical to the network device 40. Accordingly, like the network device 40, the network devices 212 and 214 are suitable for deployment as wireless repeaters. In the example of FIG. 8, the network devices 212 and 214 are remotely configurable by the administrator to operate as wireless repeaters between the network device 40 and the computer systems 196 and 198 (in the case of the network device 212) and the computer system 200 (in the case of the network device 214).

The network device 212 operates as such a repeater if it is within a wireless communication range of the network device 40 and the computer systems 196 and 198, so that the computer systems 196 and 198 communicate with the public switched network 210 via the network devices 40 and 212. Similarly, the network device 214 operates as such a repeater if it is within a wireless communication range of the network device 212 and the computer system 200, so that the computer system 200 communicates with the public switched network 210 via the network devices 40, 212 and 214. Likewise, the network devices 212 and 214 operate as such repeaters between the network device 40 and other suitably equipped computer systems that are located within a wireless communication range of the network devices 212 or 214 (so long as the network devices 40, 212 and 214 are directly or indirectly within a wireless communication range of one another).

Further, the network 192 includes a network device 216, which is substantially identical to the network device 40. The network device 216 is configurable by the administrator to operate as a repeater in a substantially identical manner as the network devices 212 and 214, except that the network device 216 is connected via a cable 218 to the network device 214 (and communicates via the cable 218, instead of wirelessly, with the network device 214). With the cable 218, the network device 216 operates as such a repeater, irrespective of whether it is within a wireless communication range of the network devices 40, 212 or 214.

Such a connection via the cable 218 between the network devices 214 and 216 is especially helpful if: (a) a receptacle of a conventional AC power source is not accessible within a wireless communication range of the network devices 40, 212 or 214; or (b) objectives of the network 192 otherwise specify a distance (between the network device 216 and the other network devices) beyond the wireless communication range of such network devices. Likewise, such a connection via a cable is optional between any of the network devices.

Accordingly, if the network device 216 is within a wireless communication range of the computer systems 202 and 204, the computer systems 202 and 204 communicate with the public switched network 210 via the network devices 40, 212, 214 and 216. Likewise, the network device 216 operates as such a repeater between the network device 40 and other suitably equipped computer systems that are located within a wireless communication range of the network device 216 (so long as the network devices 40, 212 and 214 are directly or indirectly within a wireless communication range of one another).

In that manner, the network devices 212, 214 and 216 form a backbone for channeling wireless communications through the network device 40, so that the network device 40 operates as a master wireless access point for the network 192. In the illustrative embodiments, the network devices 40, 212 and 214 communicate with one another via a first wireless frequency carrier, while the computer systems 194, 196, 198, 200, 202 and 204 communicate with the network devices 40, 212, 214 and 216 via a second wireless frequency carrier. In that manner, the network 192 reduces bandwidth degradation from interference between such wireless communications. Moreover, in an effort to further reduce such interference, the administrator may adjust respective power thresholds of the network devices 40, 212 and 214, in accordance with an environment of the network 192 (e.g., in accordance with a distance between adjacent floors of a building where the network 192 is installed).

In the example of FIG. 8, the network devices 40, 212, 214 and 216 are compliant with the same IEEE wireless communication standard and operate with only a small degradation of performance in comparison to a fully wired alternative. In an alternative embodiment, the network devices 40, 212, 214 and 216 are compliant with multiple wireless communication standards.

In comparison to the network 154 of FIG. 7, the network 192 includes a smaller amount of cabling for installation in large buildings and other wide areas. Accordingly, for installation in some environments, such as schools, airports, buildings with asbestos, hospitals, historical buildings, and hotels, the network 192 is less expensive than the network 154 of FIG. 7.

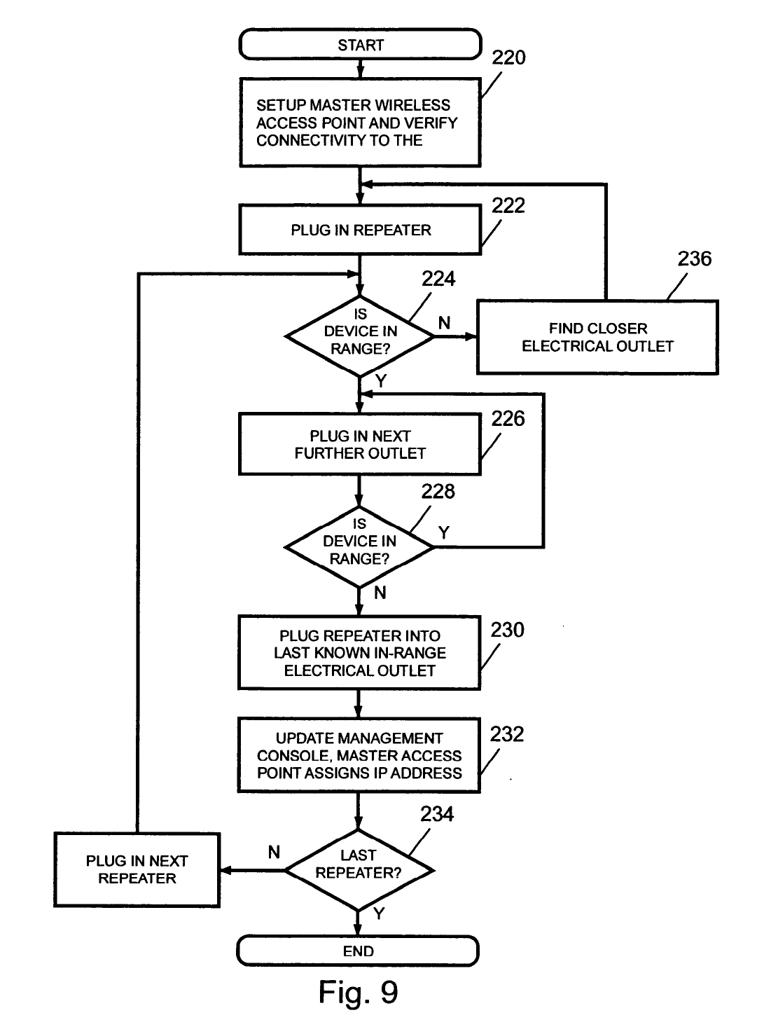

FIG. 9 is a flowchart of an installation and configuration operation, according to the illustrative embodiments. The operation begins at a step 220, at which a human user: (a) installs the network device 40 by inserting it into a receptacle pair of the conventional AC power source (e.g., a receptacle pair that is mounted within and exposed to an outer surface of a wall, as discussed further hereinabove in connection with FIGS. 2A-C); (b) connects the network device 40 via the network connection 208 to the public switched network 210; (c) verifies the communication between the network device 40 and the public switched network 210; and (d) remotely configures the network device 40 as a master wireless access point.

After the step 220, the operation continues to a step 222, at which the user installs the network device 212 by inserting it into a different receptacle pair of the conventional AC power source. After the step 222, the operation continues to a step 224, at which the user tests the location of the different receptacle pair by viewing an LED of the network device 212 (e.g., a suitable one of the LEDs 52), which illuminates if the network device 212 is within a wireless communication range of the network devices 40 and 212.

In the illustrative embodiments, the preferred receptacle pair (for powering the network device 212) is the one located farthest away from the network device 40, while being within a wireless communication range of the network devices 40 and 212. In that manner, a geographical space is serviced by fewer network devices, thereby reducing financial and administrative expense. Accordingly, if the user determines (by viewing the LED) that the network device 212 is within a wireless communication range of the network devices 40 and 212, the operation continues from the step 224 to a step 226. At the step 226, the user (a) removes the network device 212 from the present receptacle pair and (b) inserts the network device 212 into a next receptacle pair at a location that is physically less proximate to the network device 40.

After the step 226, the operation continues to a step 228 for the next receptacle pair, at which the user tests the location of such receptacle pair by viewing an LED of the network device 212, which illuminates if the network device 212 is within a wireless communication range of the network devices 40 and 212. If the user determines (by viewing the LED) that the network device 212 is within a wireless communication range of the network devices 40 and 212, the operation returns from the step 228 to the step 226. Conversely, if the user determines (by viewing the LED) that the network device 212 is beyond the wireless communication range of the network devices 40 and 212, the operation continues from the step 228 to a step 230.

At the step 230, the user: (a) removes the network device 212 from the present receptacle pair; and (b) reinserts the network device 212 into the receptacle pair at the next most recently tested location that is physically more proximate to the network device 40, and at which the LED of the network device 212 illuminated as a result of the network device 212 being within a wireless communication range of the network devices 40 and 212. Such receptacle pair (at the next most recently tested location) is the selected receptacle pair. In that manner, the user identifies the selected receptacle pair as the preferred receptacle pair (for powering the network device 212), which is the one located farthest away from the network device 40, while being within a wireless communication range of the network devices 40 and 212.

After the step 230, the operation continues to a step 232, at which the user: (a) verifies the communication between the network devices 40 and 212; and (b) remotely configures the network device 212 as a wireless repeater, which includes assignment of an IP address to the network device 212. After the step 232, the operation continues to a step 234, at which the user determines whether the network 192 includes an additional network device (for operation as a repeater) that has not yet been inserted into its respective selected receptacle pair and configured. If so, the operation returns from the step 234 to the step 222 for the additional network device. Conversely, if all network devices of the network 192 have been inserted into their respective selected receptacle pairs and configured, the operation ends.

Referring again to the step 224, if the user determines (by viewing the LED) that the network device 212 is beyond a wireless communication range of the network devices 40 and 212, the operation continues from the step 224 to a step 236. At the step 236, the user (a) removes the network device 212 from the present receptacle pair and (b) inserts the network device 212 into a next receptacle pair at a location that is physically more proximate to the network device 40. After the step 236, the operation returns to the step 222 for the next receptacle pair.

With the operation of FIG. 9, the wireless communication ranges of the network devices 40 and 212 partly overlap with one another, so that a computer system (e.g., the computer system 198) is free to relocate (e.g., roam) back-and-forth within the wireless communication ranges of the network devices 40 and 212 (or within at least one of such ranges) and thereby continuously maintain a wireless connection to the public switched network 210 by communicating via the network device 40 and/or the network device 212. By installing and configuring the network device 212 to operate as such a wireless repeater, the network 192 reduces the amount of networking cable that might otherwise be required. With the operation of FIG. 9, installation and configuration is relatively streamlined in an effort to avoid a more expensive site survey.

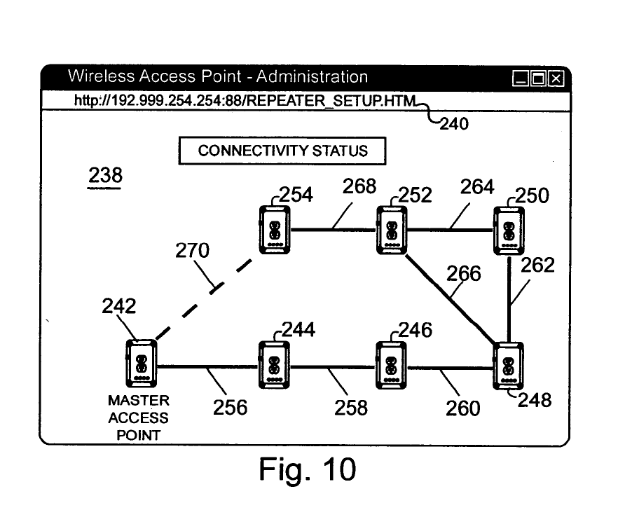

FIG. 10 is a view of a screen 238 displayed by a display device of the human administrator's computer system that is connected via the network 192 to the network devices 40, 212, 214 and 216, according to the illustrative embodiments. The computer system executes browser software, such as Microsoft Internet Explorer software. Each of the network devices 40, 212, 214 and 216 has a respective assigned IP address and is configured via the network 192 and the computer system's browser software.

The screen 238 is a graphical user interface management console screen, which is displayed by the display device in response to (a) the computer system's execution of the browser software and (b) signals from the network devices 40, 212, 214 and 216. The network devices 40, 212, 214 and 216 (in response to their programmed instructions and data) output those signals via the network 192 to the computer system for causing the display device to display various elements of the screen 238.

For security purposes, in the illustrative embodiments, the network device 40 outputs signals via the network 192 to the computer system for causing the display device to display a different screen before the screen 238. The different screen asks the administrator to enter a login name and password via the browser software before obtaining access to the screen 238.

The screen 238 includes a Uniform Resource Locator (“URL”) field 240, which is a region of the screen 238 in which the administrator is able to specify a URL address. In the example of FIG. 5, the administrator-specified URL address is http://192.999.254.254:88/WIRELESS_SETUP.HTM, which specifies the route via the network to the network devices 40, 212, 214 and 216 (which are suitable for operation as global computer network facilities).

Although FIG. 8 shows only network devices 40, 212, 214 and 216, it should be understood that additional network devices (e.g., substantially identical to the network device 40) are installable for wireless communication with the public switched network via the network device 40. In FIG. 10, the screen 238 depicts icons 242, 244, 246, 248, 250, 252 and 254, which respectively notify the administrator that the network 192 includes seven network devices, namely: (a) the network device 40, which is represented by the icon 242; (b) the network device 212, which is represented by the icon 244; (c) the network device 214, which is represented by the icon 246; (d) the network device 216, which is represented by the icon 248; and (e) first, second and third additional network devices, which are represented by the icons 250, 252 and 254, respectively.

Also, the screen 238 depicts lines 256, 258, 260, 262, 264, 266, 268 and 270, which notify the administrator of the manner in which the seven network devices communicate with one another via the network 192. In the example of FIG. 10: (a) the line 256 represents a valid connection (e.g., communication path) between the network devices 40 and 212; (b) the line 258 represents a valid connection between the network devices 212 and 214; (c) the line 260 represents a valid connection between the network devices 214 and 216; (d) the line 262 represents a valid connection between the network device 216 and the first additional network device; (e) the line 264 represents a valid connection between the first and second additional network devices; (f) the line 266 represents a valid connection between the network device 216 and the second additional network device; (g) the line 268 represents a valid connection between the second and third additional network devices; and (h) the dotted line 270 represents a failed (but previously valid) connection between the network device 40 and the third additional network device.

The connections represented by the lines 262, 264 and 266 achieve redundancy for fault-tolerant operation of the network 192. For example, even if the network device 250 fails, a valid connection remains between the network device 40 and the third additional network device via the remaining network devices. Similarly, even if any single one of the connections represented by the lines 262, 264 and 266 fails, a valid connection remains (either directly or indirectly) between all of the network devices in the network 192. Such routing and redundancy is achieved with IEEE standard 802.1 spanning tree techniques and Simple Network Management Protocol (“SNMP”) network management techniques. If a network device or a connection fails in the network 192, the administrator is able to readily identify such failure by viewing a dotted line (e.g., the dotted line 270) on the screen 238. By readily identifying such failure, a remedy (e.g., replacement or repair) is more quickly achievable.

In alternative embodiments, the network device 40 includes circuitry for operation as a wireless router, a wired hub/switch (e.g., Ethernet), and/or a cable/DSL modem. In such alternative embodiments, the network device 40 includes suitable network connection jacks, reset switches, diagnostic LEDs, USB ports, infrared ports, external antennajacks, PCMCIA card slots, memory card slots, IEEE 1394 ports, and other device interfaces.

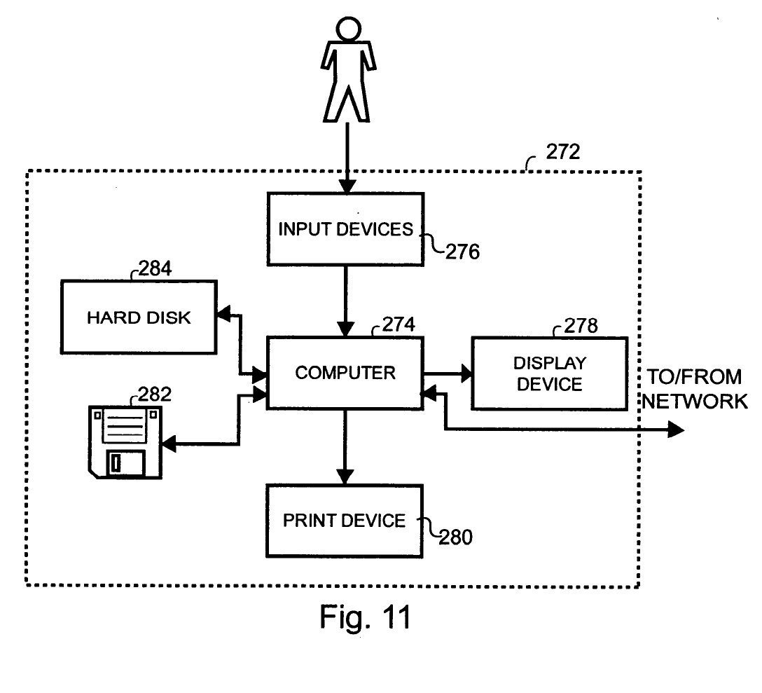

FIG. 11 is a block diagram of a representative computer system 272, according to the illustrative embodiments. The computer system 272 is connectable to the devices of network 192 either: (a) directly on a device-by-device basis; or (b) indirectly via the public switched network 210. Although the computer system 272 is discussed below in association with the human administrator, the computer system 272 is likewise representative of the computer systems 194, 196, 198, 200, 202 or 204. Accordingly, any of the computer systems 194, 196, 198, 200, 202 or 204 is operable to serve in association with the human administrator, as the human administrator's computer system.

As shown in FIG. 11, the computer system 272 includes (a) a computer 274 for executing and otherwise processing instructions, (b) input devices 276 for receiving information from the administrator, (c) a display device 278 (e.g., a conventional electronic cathode ray tube (“CRT”) device) for displaying information to the administrator, (d) a print device 280 (e.g., a conventional electronic printer or plotter), (e) a computer-readable medium (or apparatus) 282 for storing information, (f) a nonvolatile storage device 284 (e.g., a disk drive or other computer-readable medium (or apparatus), as discussed further hereinbelow) for storing information, and (g) various other electronic circuitry for performing other operations of the computer system 272.

In the illustrative embodiments, the computer 274 is an IBM-compatible computer that executes Microsoft Windows NT operating system (“OS”) software, or alternatively is any computer that executes any OS. All Microsoft products identified herein are available from Microsoft Corporation, One Microsoft Way, Redmond, Wash. 98052-6399, telephone (425) 882-8080. For example, the computer 274 includes (a) a network interface (e.g., asynchronous transfer mode (“ATM”) circuitry) for communicating information between the computer 274 and the public switched network, and (b) a memory device (e.g., random access memory (“RAM”) device and read only memory (“ROM”) device) for storing information (e.g., instructions executed by the computer 274, and data operated upon by the computer 274 in response to such instructions).

Accordingly, the computer 274 is connected to the public switched network, input devices 276, display device 278, print device 280, computer-readable medium 282, and storage device 284, as shown in FIG. 11. The computer system 272 and the administrator operate in association with one another.

For example, the administrator operates the input devices 276 for outputting information to the computer 274, and the computer 274 receives such information from the input devices 276. Moreover, in response to signals from the computer 274, the display device 278 displays visual images, and the administrator views such visual images. Also, in response to signals from the computer 274, the print device 280 prints visual images on paper, and the administrator views such visual images.

The input devices 276 include, for example, a conventional electronic keyboard and a pointing device such as a conventional electronic “mouse,” rollerball or light pen. The administrator operates the keyboard to output alphanumeric text information to the computer 274, and the computer 274 receives such alphanumeric text information from the keyboard. The administrator operates the pointing device to output cursor-control information to the computer 274, and the computer 274 receives such cursor-control information from the pointing device.

In the illustrative embodiments, the computer-readable medium 282 is a floppy diskette. The computer-readable medium 282 and the computer 274 are structurally and functionally interrelated with one another, as discussed further hereinbelow. Each computer system of the illustrative embodiments is structurally and functionally interrelated with a respective computer-readable medium, similar to the manner in which the computer 274 is structurally and functionally interrelated with the computer-readable medium 282. In that manner, the computer-readable medium 282 is a representative one of such computer-readable media, including for example but not limited to the storage device 284.

The computer-readable medium 282 stores (or encodes, or records, or embodies) functional descriptive material (e.g., including but not limited to computer programs (also referred to as computer applications) and data structures). Such functional descriptive material imparts functionality when encoded on the computer-readable medium 282. Also, such functional descriptive material is structurally and functionally interrelated to the computer-readable medium 282.

Within such functional descriptive material, data structures define structural and functional interrelationships between such data structures and the computer-readable medium 282 (and other aspects of the computer system 272). Such interrelationships permit the data structures' functionality to be realized. Also, within such functional descriptive material, computer programs define structural and functional interrelationships between such computer programs and the computer-readable medium 282 (and other aspects of the computer system 272). Such interrelationships permit the computer programs' functionality to be realized.

For example, the computer 274 reads (or accesses, or copies) such functional descriptive material from the computer-readable medium 282 into the memory device of the computer system 272, and the computer system 272 performs its operations (as discussed elsewhere herein) in response to such material which is stored in the memory device of the computer system 272. More particularly, the computer system 272 performs the operation of processing a computer application (that is stored, encoded, recorded or embodied on a computer-readable medium) for causing the computer system 272 to perform additional operations (as discussed elsewhere herein). Accordingly, such functional descriptive material exhibits a functional interrelationship with the way in which the computer system 272 executes its processes and performs its operations.

Further, the computer-readable medium is an apparatus from which the computer application is accessible by the computer 274, and the computer application is processable by the computer 274 for causing the computer system 272 to perform such additional operations. In addition to reading such functional descriptive material from the computer-readable medium 282, the computer system 272 is capable of reading such functional descriptive material from (or via) the public switched network which is also a computer-readable medium (or apparatus). Moreover, the memory device of the computer system 272 is itself a computer-readable medium (or apparatus).

Although illustrative embodiments have been shown and described, a wide range of modification, change and substitution is contemplated in the foregoing disclosure and, in some instances, some features of the embodiments may be employed without a corresponding use of other features.

What is claimed is:

1. A network device, comprising:
a housing;
circuitry within the housing for multiplexing a communication of information between first, second and third communication devices, wherein the circuitry includes a first connection for connecting to the first communication device, a second connection for connecting to the second communication device, a third connection for connecting to the third communication device, and a power connection for connecting the circuitry to an alternating current power source, and wherein the first, second and third communication devices are external to the housing;
a group of electrical prongs, mounted to the housing, for insertion into at least one primary receptacle of the alternating current power source, and for mechanically supporting at least a portion of the housing's weight when the group of electrical prongs is so inserted, wherein at least a portion of the group of electrical prongs is connected to the power connection for connecting the circuitry to the alternating current power source via the power connection and the group of electrical prongs when the group of electrical prongs is so inserted;
a first extension receptacle, mounted to the housing and connected to the group of electrical prongs, into which a first plug of a first extension device is insertable, for connecting the first extension device to the alternating current power source via the first plug and the group of electrical prongs when the first plug and the group of electrical prongs are so inserted; and
a second extension receptacle, mounted to the housing and connected to the group of electrical prongs, into which a second plug of a second extension device is insertable, for connecting the second extension device to the alternating current power source via the second plug and the group of electrical prongs when the second plug and the group of electrical prongs are so inserted.

2. The network device of claim 1, wherein the circuitry includes a power conditioning module for conditioning power from the alternating current power source, and wherein:
the power connection is for connecting the circuitry to the alternating current power source via the power connection, the power conditioning module, and the group of electrical prongs when the group of electrical prongs is so inserted;
the first extension receptacle is for connecting the first extension device to the alternating current power source via the first plug, the power conditioning module, and the group of electrical prongs when the first plug and the group of electrical prongs are so inserted; and
the second extension receptacle is for connecting the second extension device to the alternating current power source via the second plug, the power conditioning module, and the group of electrical prongs when the second plug and the group of electrical prongs are so inserted.

3. The network device of claim 1, wherein the circuitry includes a surge protection module for protecting the circuitry against a surge in power from the alternating current power source, and wherein:
the power connection is for connecting the circuitry to the alternating current power source via the power connection, the surge protection module, and the group of electrical prongs when the group of electrical prongs is so inserted;
the first extension receptacle is for connecting the first extension device to the alternating current power source via the first plug, the surge protection module, and the group of electrical prongs when the first plug and the group of electrical prongs are so inserted; and
the second extension receptacle is for connecting the second extension device to the alternating current power source via the second plug, the surge protection module, and the group of electrical prongs when the second plug and the group of electrical prongs are so inserted.

4. The network device of claim 1, wherein the group of electrical prongs includes:
a first group of electrical prongs, mounted to the housing, for insertion into a first primary receptacle of the alternating current power source, and for mechanically supporting at least a portion of the housing's weight when the first group of electrical prongs is so inserted, wherein the first group of electrical prongs is connected to the power connection for connecting the circuitry to the alternating current power source via the power connection and the first group of electrical prongs when the first group of electrical prongs is so inserted, wherein the first extension receptacle is connected to the first group of electrical prongs for connecting the first extension device to the alternating current power source via the first plug and the first group of electrical prongs when the first plug and the first group of electrical prongs are so inserted; and
a second group of electrical prongs, mounted to the housing, for insertion into a second primary receptacle of the alternating current power source, and for mechanically supporting at least a portion of the housing's weight when the second group of electrical prongs is so inserted, wherein the second extension receptacle is connected to the second group of electrical prongs for connecting the second extension device to the alternating current power source via the second plug and the second group of electrical prongs when the second plug and the second group of electrical prongs are so inserted.

5. The network device of claim 4, wherein the circuitry includes a power conditioning module for conditioning power from the alternating current power source, and wherein:
the power connection is for connecting the circuitry to the alternating current power source via the power connection, the power conditioning module, and the first group of electrical prongs when the first group of electrical prongs is so inserted;
the first extension receptacle is for connecting the first extension device to the alternating current power source via the first plug, the power conditioning module, and the first group of electrical prongs when the first plug and the first group of electrical prongs are so inserted; and
the second extension receptacle is for connecting the second extension device to the alternating current power source via the second plug, the power conditioning module, and the second group of electrical prongs when the second plug and the second group of electrical prongs are so inserted.

6. The network device of claim 4, wherein the circuitry includes a surge protection module for protecting the circuitry against a surge in power from the alternating current power source, and wherein:
the power connection is for connecting the circuitry to the alternating current power source via the power connection, the surge protection module, and the first group of electrical prongs when the first group of electrical prongs is so inserted;
the first extension receptacle is for connecting the first extension device to the alternating current power source via the first plug, the surge protection module, and the first group of electrical prongs when the first plug and the first group of electrical prongs are so inserted; and
the second extension receptacle is for connecting the second extension device to the alternating current power source via the second plug, the surge protection module, and the second group of electrical prongs when the second plug and the second group of electrical prongs are so inserted.

7. The network device of claim 1, wherein the circuitry is remotely controllable by the first communication device.

8. The network device of claim 1, wherein the second connection is for connecting to the second communication device via a wireless medium.

9. The network device of claim 8, wherein the circuitry includes:
circuitry for selecting a manner of communicating the information between the second connection and the second communication device via the wireless medium, including at least one of the following: wireless communication standard selection, mode selection, and channel selection.

10. The network device of claim 9, wherein the circuitry is remotely controllable by the first communication device.

11. The network device of claim 1, wherein the circuitry is mounted to the housing, and wherein the group of electrical prongs is mounted to the housing by mounting to the circuitry.

12. The network device of claim 1, wherein the second communication device is the first extension device.

13. The network device of claim 1, wherein the primary receptacle has a connector type, and wherein the first extension receptacle has the connector type.

14. The network device of claim 1, wherein the primary receptacle is mounted within a wall and is exposed to an outer surface of the wall, and comprising:
a structure for securing the housing to the wall when the group of electrical prongs is so inserted.

15. The network device of claim 14, wherein the structure includes a screw for securing the housing to the wall.

16. The network device of claim 14, wherein the structure includes a locking device for selectively preventing detachment of the housing from the wall.

17. The network device of claim 16, wherein the structure includes a screw for securing the housing to the wall, and wherein the locking device includes a cover for selectively preventing access to the screw.

18. The network device of claim 14, wherein the structure is for securing the housing to the wall by securing the housing to the receptacle.

19. A network device, comprising:
a housing;
circuitry within the housing for communicating information between first and second communication devices, wherein the circuitry includes a first connection for connecting to the first communication device, a second connection for connecting to the second communication device, and a power connection for connecting the circuitry to an alternating current power source;
a group of electrical prongs, mounted to the housing, for insertion into at least one primary receptacle of the alternating current power source, and for mechanically supporting at least a portion of the housing's weight when the group of electrical prongs is so inserted, wherein at least a portion of the group of electrical prongs is connected to the power connection for connecting the circuitry to the alternating current power source via the power connection and the group of electrical prongs when the group of electrical prongs is so inserted; and
an extension receptacle, mounted to the housing and connected to the group of electrical prongs, into which a plug of an extension device is insertable, for connecting the extension device to the alternating current power source via the plug and the group of electrical prongs when the plug and the group of electrical prongs are so inserted.

20. The network device of claim 19, wherein the extension receptacle is a first extension receptacle, wherein the extension device is a first extension device, wherein the plug is a first plug of the first extension device, and comprising:
a second extension receptacle, mounted to the housing and connected to the group of electrical prongs, into which a second plug of a second extension device is insertable, for connecting the second extension device to the alternating current power source via the second plug and the group of electrical prongs when the second plug and the group of electrical prongs are so inserted.

21. The network device of claim 20, wherein the group of electrical prongs includes:
a first group of electrical prongs, mounted to the housing, for insertion into a first primary receptacle of the alternating current power source, and for mechanically supporting at least a portion of the housing's weight when the first group of electrical prongs is so inserted, wherein the first group of electrical prongs is connected to the power connection for connecting the circuitry to the alternating current power source via the power connection and the first group of electrical prongs when the first group of electrical prongs is so inserted, wherein the first extension receptacle is connected to the first group of electrical prongs for connecting the first extension device to the alternating current power source via the first plug and the first group of electrical prongs when the first plug and the first group of electrical prongs are so inserted; and
a second group of electrical prongs, mounted to the housing, for insertion into a second primary receptacle of the alternating current power source, and for mechanically supporting at least a portion of the housing's weight when the second group of electrical prongs is so inserted, wherein the second extension receptacle is connected to the second group of electrical prongs for connecting the second extension device to the alternating current power source via the second plug and the second group of electrical prongs when the second plug and the second group of electrical prongs are so inserted.

22. The network device of claim 19, wherein the circuitry includes a power conditioning module for conditioning power from the alternating current power source, and wherein:
the power connection is for connecting the circuitry to the alternating current power source via the power connection, the power conditioning module, and the group of electrical prongs when the group of electrical prongs is so inserted; and
the extension receptacle is for connecting the extension device to the alternating current power source via the plug, the power conditioning module, and the group of electrical prongs when the plug and the group of electrical prongs are so inserted.

23. The network device of claim 19, wherein the circuitry includes a surge protection module for protecting the circuitry against a surge in power from the alternating current power source, and wherein:
the power connection is for connecting the circuitry to the alternating current power source via the power connection, the surge protection module, and the group of electrical prongs when the group of electrical prongs is so inserted; and
the extension receptacle is for connecting the extension device to the alternating current power source via the plug, the surge protection module, and the group of electrical prongs when the plug and the group of electrical prongs are so inserted.

24. The network device of claim 19, wherein the circuitry is remotely controllable by the first communication device.

25. The network device of claim 19, wherein the second connection is for connecting to the second communication device via a wireless medium.

26. The network device of claim 25, wherein the circuitry includes:
circuitry for selecting a manner of communicating the information between the second connection and the second communication device via the wireless medium, including at least one of the following: wireless communication standard selection, mode selection, and channel selection.

27. The network device of claim 26, wherein the circuitry is remotely controllable by the first communication device.

28. The network device of claim 19, wherein the circuitry is mounted to the housing, and wherein the group of electrical prongs is mounted to the housing by mounting to the circuitry.

29. The network device of claim 19, wherein the second communication device is the extension device.

30. The network device of claim 19, wherein the primary receptacle has a connector type, and wherein the extension receptacle has the connector type.

31. The network device of claim 19, wherein the primary receptacle is mounted within a wall and is exposed to an outer surface of the wall, and comprising:
a structure for securing the housing to the wall when the group of electrical prongs is so inserted.

32. The network device of claim 31, wherein the structure includes a screw for securing the housing to the wall.

33. The network device of claim 31, wherein the structure includes a locking device for selectively preventing detachment of the housing from the wall.

34. The network device of claim 33, wherein the structure includes a screw for securing the housing to the wall, and wherein the locking device includes a cover for selectively preventing access to the screw.

35. The network device of claim 31, wherein the structure is for securing the housing to the wall by securing the housing to the receptacle.

36. The network device of claim 19, wherein the first and second communication devices are external to the housing.

37. A network device, comprising:
a housing;
circuitry within the housing for communicating information between first and second communication devices, wherein the circuitry includes a first connection for connecting to the first communication device via a wire, a second connection for connecting to the second communication device, and a power connection for connecting the circuitry to an alternating current power source; and
a group of electrical prongs, mounted to the housing, for insertion into at least one receptacle of the alternating current power source, and for mechanically supporting at least a portion of the housing's weight when the group of electrical prongs is so inserted, wherein at least a portion of the group of electrical prongs is connected to the power connection for connecting the circuitry to the alternating current power source via the power connection and the group of electrical prongs when the group of electrical prongs is so inserted.

38. The network device of claim 37, wherein the circuitry is remotely controllable by the first communication device.

39. The network device of claim 37, wherein the second connection is for connecting to the second communication device via a wireless medium.

40. The network device of claim 39, wherein the circuitry includes:
circuitry for selecting a manner of communicating the information between the second connection and the second communication device via the wireless medium, including at least one of the following: wireless communication standard selection, mode selection, and channel selection.

41. The network device of claim 40, wherein the circuitry is remotely controllable by the first communication device.

42. The network device of claim 37, wherein the circuitry is mounted to the housing, and wherein the group of electrical prongs is mounted to the housing by mounting to the circuitry.

43. The network device of claim 37, wherein the primary receptacle is mounted within a wall and is exposed to an outer surface of the wall, and comprising:
a structure for securing the housing to the wall when the group of electrical prongs is so inserted.

44. The network device of claim 43, wherein the structure includes a screw for securing the housing to the wall.

45. The network device of claim 43, wherein the structure includes a locking device for selectively preventing detachment of the housing from the wall.

46. The network device of claim 45, wherein the structure includes a screw for securing the housing to the wall, and wherein the locking device includes a cover for selectively preventing access to the screw.

47. The network device of claim 43, wherein the structure is for securing the housing to the wall by securing the housing to the receptacle.

48. The network device of claim 37, wherein the first and second communication devices are external to the housing.

49. The network device of claim 37, wherein the second connection is a parallel connection.

50. The network device of claim 37, wherein the second connection is a serial connection

51. The network device of claim 50, wherein the serial connection is a universal serial bus (“USB”) connection.

52. The network device of claim 37, wherein the wire is a first wire, and wherein the second connection is for connecting to the second communication device via a second wire.

53. The network device of claim 37, wherein the second connection is an Ethernet connection.

54. The network device of claim 37, wherein the second connections is a connection to a wide area network.

55. The network device of claim 54, wherein the wide area network is a global computer network.

56. The network device of claim 37, wherein the second connections is a connection to a print device.

57. The network device of claim 56, wherein the connection to the print device is a connection to the print device via a print server.

58. The network device of claim 37, wherein the receptacle is a primary receptacle, and comprising:
an extension receptacle, mounted to the housing and connected to the group of electrical prongs, into which a plug of an extension device is insertable, for connecting the extension device to the alternating current power source via the plug and the group of electrical prongs when the plug and the group of electrical prongs are so inserted.
